(19) United States
(12) Patent Application Publication
(10) Pub. No.: US 2015/0048576 A1
(43) Pub. Date: Feb. 19, 2015

(54) Machining Tool Holder With Vibration Preventing Capability and Lubricating Function

(71) Applicant: Good-tec Co., Ltd., Taichung City (TW)

(72) Inventor: Jen-Hong Lee, Taichung City (TW)

(73) Assignee: Good-tec Co., Ltd., Taichung City (TW)

(21) Appl. No.: 13/965,308

(22) Filed: Aug. 13, 2013

(51) Int. Cl. B23B 31/107

(52) U.S. Cl. CPC B23B 31/1075; B23B 2231/24; B23B 2250/16
USPC 279/20

(57) ABSTRACT

A machining tool holder includes: a sleeve defining a central channel and a lubricant channel and formed with annular inner grooves and fastener holes, the lubricant channel having a truncated spherical end region; fasteners extending through the fastener holes; first O-rings retained in the annular inner grooves; a truncated spherical nozzle mounted rotatably in the truncated spherical end region; and an abutting mechanism having an abutting shaft and an second O-ring. The abutting shaft extends into the central channel and defines a retaining groove. The second O-ring is retained in the retaining groove and extends outwardly of the retaining groove beyond an end face of the abutting shaft.

### BACKGROUND OF THE INVENTION

1. Field of the Invention

The invention relates to a machining tool holder with vibration preventing capability and lubricating function.

2. Description of the Related Art

FIGS. 1 to 3 illustrate a conventional machining tool holder for a machining apparatus with a lubricant delivery unit (not shown). The machining tool holder includes: a tool-holding sleeve 8 that defines a central channel 81 and a lubricant channel 82, the central channel 81 having first and second chambers 811, 812, the first chamber 811 being adapted to receive a shank of a machining tool 80, such as a cutting tool, a drilling tool, or a polishing tool, therein, the tool-holding sleeve 8 being formed with a plurality of fastener holes 813 that are in spatial communication with the first chamber 811, the lubricant channel 82 being parallel to the central channel 81, being adapted to receive a lubricant therein, and having a truncated spherical end region 821; a plurality of fasteners 83 extending respectively through the fastener holes 813 into the first chamber 811 to fasten and position the shank of the machining tool 80; a truncated spherical nozzle 84 mounted rotatably in the truncated spherical end region 821 and defining a nozzle channel 840 for passage of the lubricant therethrough; an abutting shaft 85 that is fastened to the tool-holding sleeve 8 and that extends into the second chamber 812 to abut against the machining tool 80; and a positioning screw 86 engaging threadedly a screw hole 814 in the tool-holding sleeve 8 for positioning the truncated spherical nozzle 84 at a desired angle relative to an axis of the tool-holding sleeve 8 so as to permit directing of a jet of the lubricant toward a contact area between the machining tool 80 and a workpiece 87. When machining of the workpiece 87 is finished or when lubricating is not needed during machining, the nozzle channel 840 is closed using a screw plug 88 that threadedly engages an inner thread in the truncated spherical nozzle 84.

Since the machining tool 80 vibrates upon contact with the workpiece 87 during machining, undesired wear of the machining tool 80 and loud noise arise and the precision of machining tends to be adversely affected.

### SUMMARY OF THE INVENTION

Therefore, the object of the present invention is to provide a machining tool holder that can overcome the aforesaid drawbacks associated with the prior art.

According to the present invention, there is provided a machining tool holder with vibration preventing capability and lubricating function. The machining tool holder comprises: a tool-holding sleeve that has opposite first and second axial ends and that defines a central channel and a lubricant channel, the central channel extending in an axial direction from the first axial end to the second axial end, and having first and second chambers that extend oppositely in the axial direction from each other to the first and second axial ends and that are defined by first and second chamber-defining walls, respectively, the first chamber being adapted to receive a shank of a machining tool therein, the first chamber-defining wall being formed with a plurality of annular inner grooves that are in spatial communication with the first chamber, and a plurality of fastener holes that are in spatial communication with the first chamber, the lubricant channel being parallel to the central channel, being adapted to receive a lubricant therein, and having a truncated spherical end region that is disposed adjacent to the first axial end; a plurality of fasteners extending respectively through the fastener holes into the first chamber to fasten and position the shank of the machining tool; a plurality of elastic first O-rings that are retained in the annular inner grooves, respectively, and that are adapted to be in contact with the shank of the machining tool; a truncated spherical nozzle mounted rotatably in the truncated spherical end region and defining a nozzle channel for passage of the lubricant therethrough; and an abutting mechanism having an abutting shaft and an elastic second O-ring. The abutting shaft is adjustably fastened to the second chamber-defining wall, extends into the second chamber, and has a main portion and an end portion that cooperates with the main portion to define a retaining groove therebetween and that has an end face facing in the axial direction. The second O-ring is retained in the retaining groove, and has an outer portion extending outwardly of the retaining groove in the axial direction beyond the end face of the end portion of the abutting shaft so as to permit the second O-ring to abut elastically against the shank of the machining tool.

### BRIEF DESCRIPTION OF THE DRAWINGS

In drawings which illustrate an embodiment of the invention,

FIG. 1 is an exploded perspective view of a conventional machining tool holder;

FIG. 2 is a sectional view illustrating a state where the conventional machining tool holder holds a machining tool for machining a workpiece;

FIG. 3 is a sectional view illustrating a state where a nozzle channel is closed by a screw plug of the conventional machining tool holder;

FIG. 4 is an exploded perspective view of the preferred embodiment of a machining tool holder according to the present invention;

FIG. 5 is a sectional view of the preferred embodiment;

FIG. 6 is a sectional view of the preferred embodiment illustrating a state where a truncated spherical nozzle is positioned at an angle to direct a jet of a lubricant toward a contact area between a machining tool and a workpiece;

FIG. 7 is a fragmentary partly sectional view illustrating the state of the preferred embodiment shown in FIG. 6; and

FIG. 8 is a fragmentary partly sectional view illustrating another state of the preferred embodiment where the truncated spherical nozzle is positioned at a closed position.

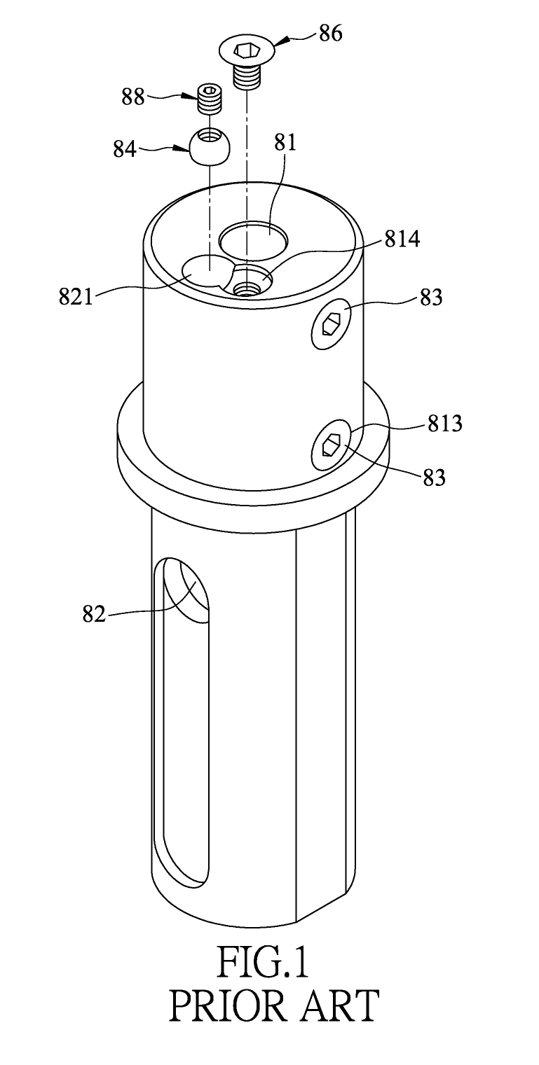

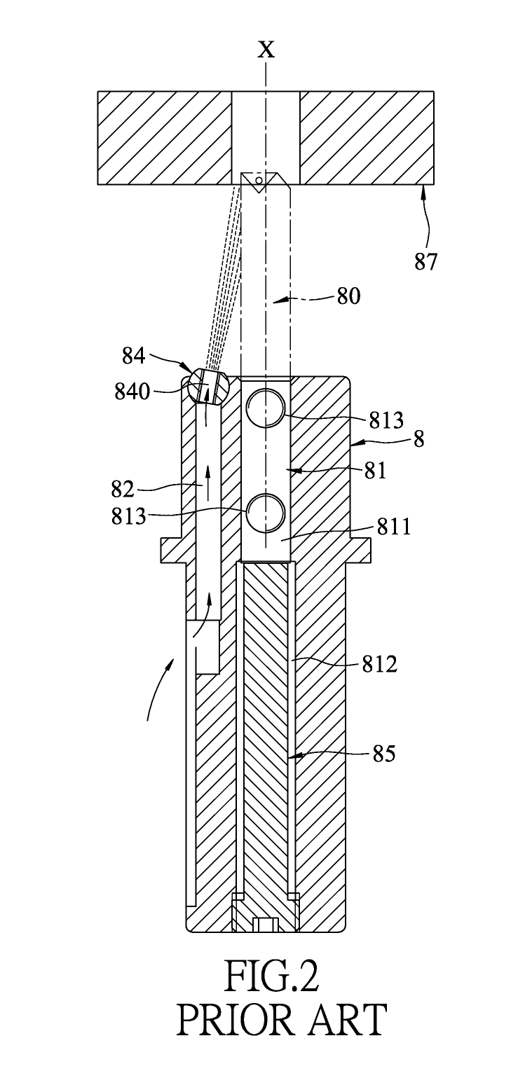

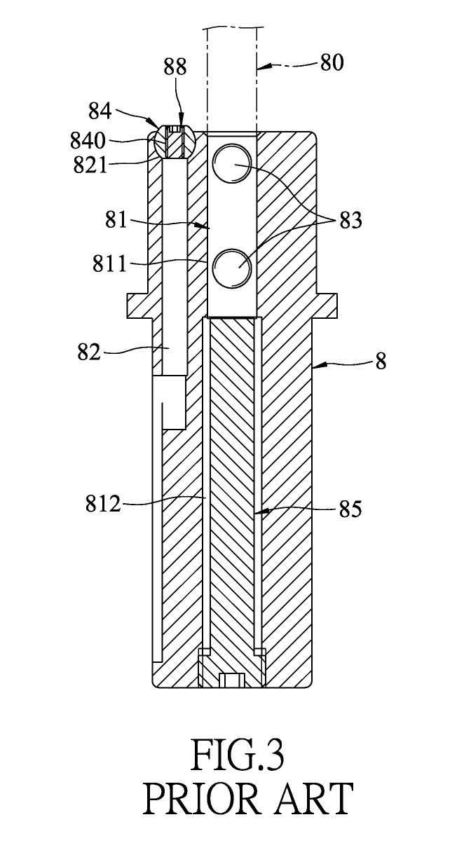

### DETAILED DESCRIPTION OF THE PREFERRED EMBODIMENT

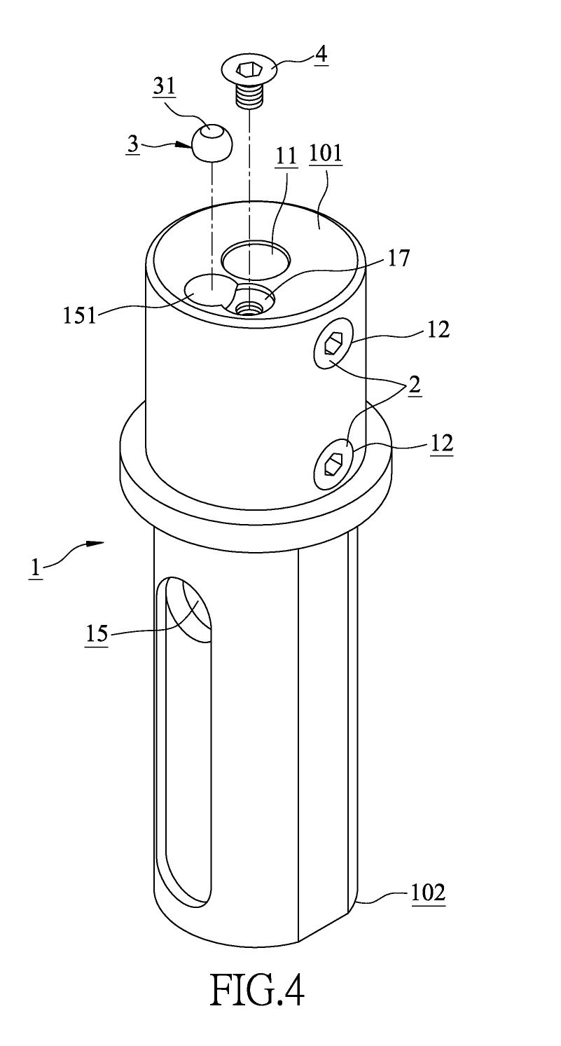

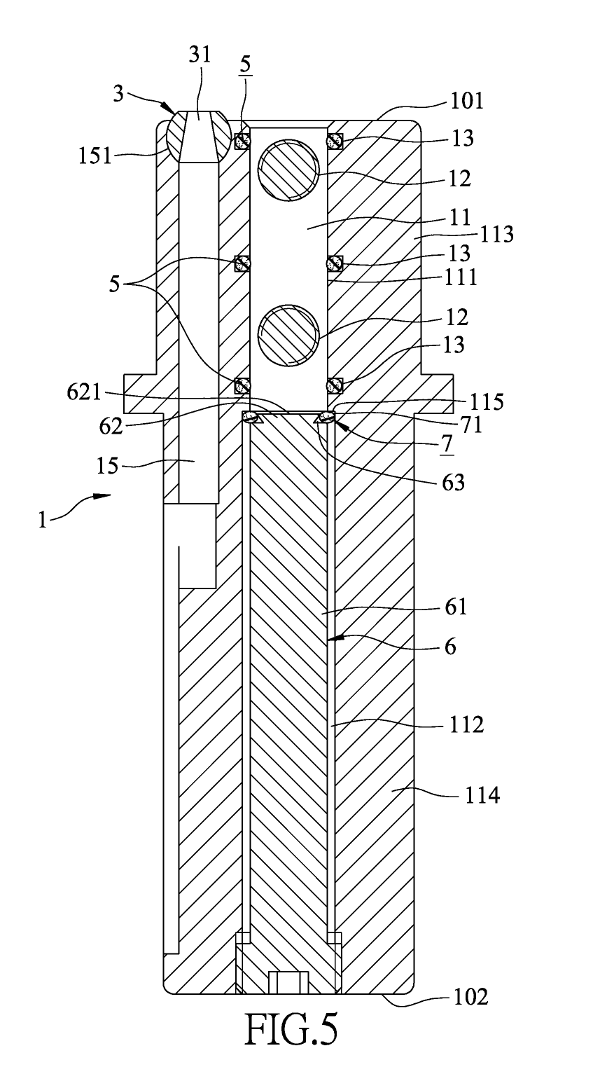

FIGS. 4 to 6 illustrate the preferred embodiment of a machining tool holder with vibration preventing capability and lubricating function according to the present invention.

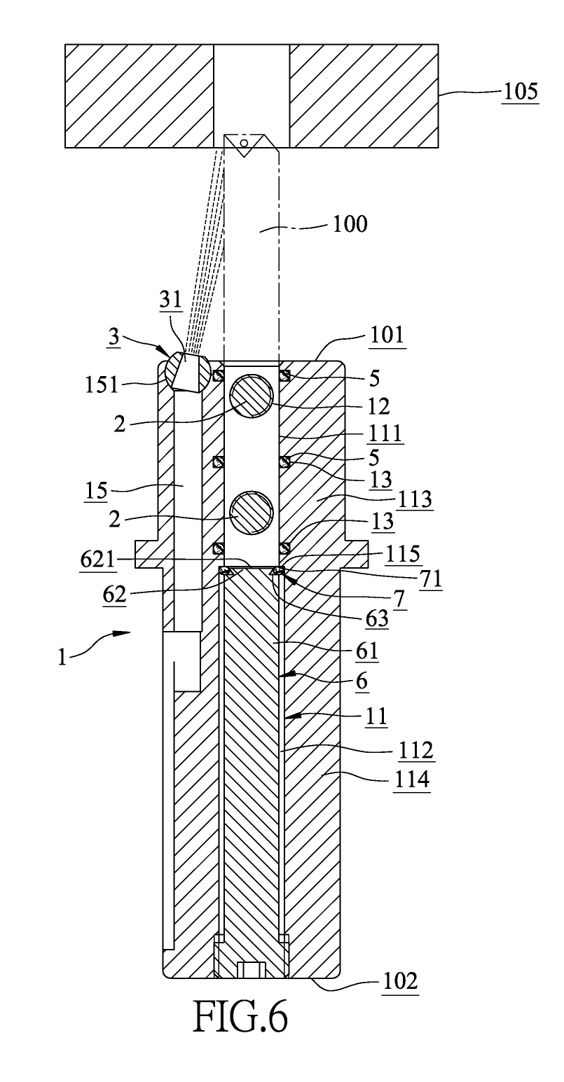

The machining tool holder is useful for holding a machining tool 100 (see FIG. 6), such as a cutting tool, a drilling tool, or a polishing tool, for machining a workpiece 105, and includes: a tool-holding sleeve 1 that has opposite first and second axial ends 101, 102 and that defines a central channel 11 and a lubricant channel 15, the central channel 11 extending in an axial direction from the first axial end 101 to the second axial end 102, and having first and second chambers 111, 112 that extend oppositely in the axial direction from each other to the first and second axial ends 101, 102, and that are defined by first and second chamber-defining walls 113, 114, respectively, the first chamber 111 being adapted to receive a shank of the machining tool 100 therein, the first chamber-defining wall 113 being formed with a plurality of annular inner grooves 13 that are in spatial communication with the first chamber 111, and a plurality of fastener holes 12 that are in spatial communication with the first chamber 111, the lubricant channel 15 being parallel to the central channel 11, being adapted to receive a lubricant therein, and having a truncated spherical end region 151 that is disposed adjacent to the first axial end 101; a plurality of fasteners 2 extending respectively through the fastener holes 12 into the first chamber 111 to fasten and position the shank of the machining tool 100; a plurality of elastic first O-rings 5 that are retained in the annular inner grooves 13, respectively, and that are adapted to be in frictional contact with the shank of the machining tool 100; a truncated spherical nozzle 3 mounted rotatably in the truncated spherical end region 151 and defining a nozzle channel 31 for passage of the lubricant therethrough, the nozzle channel 31 having a truncated conical shape; and an abutting mechanism having an abutting shaft 6 and an elastic second O-ring 7. The abutting shaft 6 is adjustably fastened to the second chamber-defining wall 114 in a thread-engaging manner, extends into the second chamber 112, and has a main portion 61 and an end portion 62 that cooperates with the main portion 61 to define a retaining groove 63 therebetween and that has an end face 621 facing in the axial direction. The second O-ring 7 is retained in the retaining groove 63, and has an outer portion 71 extending outwardly of the retaining groove 63 in the axial direction beyond the end face 621 of the end portion 62 of the abutting shaft 6 so as to permit the second O-ring 7 to abut elastically against the shank of the machining tool 100.

In this embodiment, the end portion 62 of the abutting shaft 6 has a dovetail-shaped cross-section such that the retaining groove 63 is tapered in shape.

The first chamber 111 is reduced in diameter from the second chamber 112. The first and second chamber-defining walls 113, 114 cooperate with each other to define an inner shoulder 115 therebetween. The second O-ring 7 abuts against the inner shoulder 115 and the second chamber-defining wall 114.

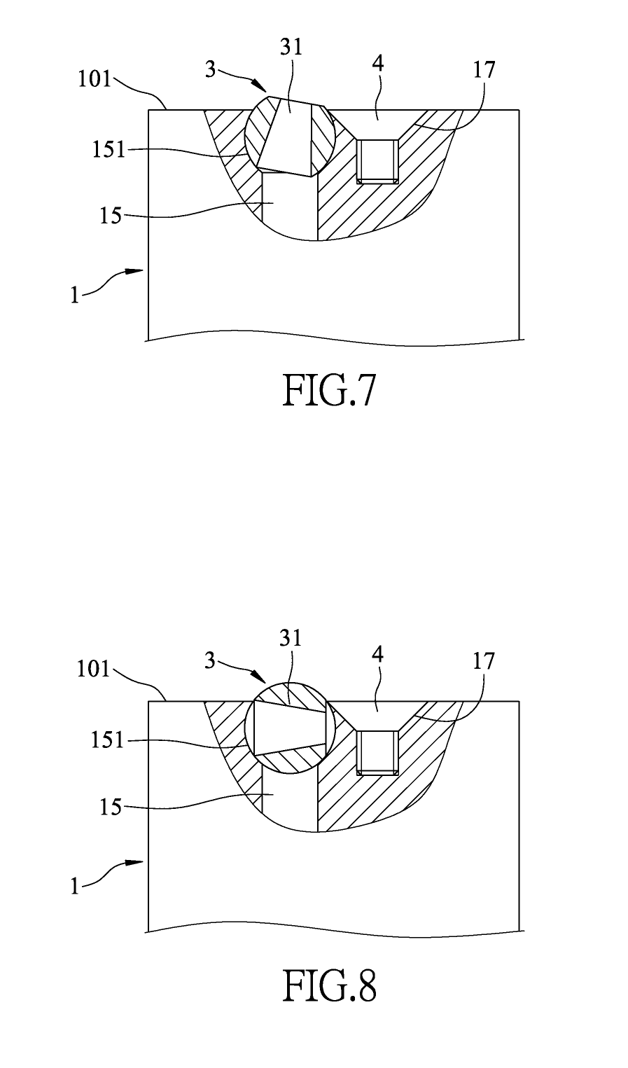

A positioning member 4, such as a screw, is mounted adjustably on the first chamber-defining wall 113 by engaging threadedly a screw hole 17 in the first chamber-defining wall 113 for pressing the truncated spherical nozzle 3 (see FIG. 7) and positioning the truncated spherical nozzle 3 at a desired angle relative to the axial direction so as to direct a jet of the lubricant delivered out of the nozzle channel 31 toward a contact area between the machining tool 100 and the workpiece 105 (see FIG. 6). When machining of the workpiece 105 is finished or when lubricating is not needed during machining, the nozzle channel 31 is closed by rotating the truncated spherical nozzle 3 relative to the tool-holding sleeve 1 to a closed position (see FIG. 8), in which the lubricant channel 15 is blocked by the truncated spherical nozzle 3 and is not in fluid communication with the nozzle channel 31.

With the formation of the inner grooves 13 and the retaining groove 63 and with the inclusion of the first and second O-rings 5, 7 retained in the inner grooves 13 and the retaining groove 63, respectively, in the machining tool holder of the present invention, vibration of the machining tool 100 can be absorbed by the first and second O-rings 5, 7 during machining, thereby alleviating the aforesaid drawbacks associated with the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A machining tool holder with vibration preventing capability and lubricating function, comprising:
a tool-holding sleeve that has opposite first and second axial ends and that defines a central channel and a lubricant channel, said central channel extending in an axial direction from said first axial end to said second axial end, and having first and second chambers that extend oppositely in the axial direction from each other to said first and second axial ends and that are defined by first and second chamber-defining walls, respectively, said first chamber being adapted to receive a shank of a machining tool therein, said first chamber-defining wall being formed with a plurality of annular inner grooves that are in spatial communication with said first chamber, and a plurality of fastener holes that are in spatial communication with said first chamber, said lubricant channel being parallel to said central channel, being adapted to receive a lubricant therein, and having a truncated spherical end region disposed adjacent to said first axial end;
a plurality of fasteners extending respectively through said fastener holes into said first chamber to fasten and position the shank of the machining tool;
a plurality of elastic first O-rings that are retained in said annular inner grooves, respectively, and that are adapted to be in contact with the shank of the machining tool;
a truncated spherical nozzle mounted rotatably in said truncated spherical end region and defining a nozzle channel for passage of the lubricant therethrough; and
an abutting mechanism having an abutting shaft and an elastic second O-ring, said abutting shaft being adjustably fastened to said second chamber-defining wall, extending into said second chamber, and having a main portion and an end portion that cooperates with said main portion to define a retaining groove therebetween and that has an end face facing in the axial direction;
wherein said second O-ring is retained in said retaining groove and has an outer portion extending outwardly of said retaining groove in the axial direction beyond said end face of said end portion of said abutting shaft so as to permit said second O-ring to abut elastically against the shank of the machining tool.

2. The machining tool holder of claim 1, wherein said end portion of said abutting shaft has a dovetail-shaped cross-section such that said retaining groove is tapered in shape.

3. The machining tool holder of claim 1, wherein said first chamber is reduced in diameter from said second chamber, said first and second chamber-defining walls cooperating with each other to define an inner shoulder therebetween, said second O-ring abutting against said inner shoulder and said second chamber-defining wall.

4. The machining tool holder of claim 1, wherein said nozzle channel has a truncated conical shape.

5. The machining tool holder of claim 1, further comprising a positioning member that is mounted adjustably on said first chamber-defining wall to press said truncated spherical nozzle for positioning said truncated spherical nozzle at a desired angle relative to the axial direction.
